(19) United States
(12) Patent Application Publication
(10) Pub. No.: US 2004/0025591 A1
(43) Pub. Date: Feb. 12, 2004

(54) Accleration sensor

(76) Inventors: Eiji Yoshikawa, Tokyo (JP); Masahiro Tsugai, Tokyo (JP); Nobuaki Konno, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 10/450,054

(22) PCT Filed: Nov. 19, 2001
(86) PCT No.: PCT/JP01/10092

(51) Int. Cl. G01P 15/125; G01P 21/00

(52) U.S. Cl. 73/514.32; 73/1.38

(57) ABSTRACT

First and second fixed electrodes provided on a substrate, a movable electrode which is provided above the first and second fixed electrodes facing against them, and is elastically supported on the substrate by a first elastic supporting body and is swingable, a mass which is elastically supported on the substrate by a second elastically supporting body and is movable in response to an acceleration in a direction perpendicular to the substrate, and a linking portion for linking the movable electrode and the mass at a position away from a swing axis of the movable electrode by a predetermined distance are provided. An acceleration is measured based on changes in a first capacitance provided by the first fixed electrode and the movable electrode and a second capacitance provided by the second fixed electrode and the movable electrode. Thus, a high impact resistant and highly reliable acceleration sensor can be obtained.

### TECHNICAL FIELD

The present invention relates to an acceleration sensor and, in particular, to a highly reliable, high impact resistant acceleration sensor.

### BACKGROUND ART

FIG. 16 is a plan view of a conventional acceleration sensor, which is disclosed in Japan Laid Open Hei5-133976, for example. FIG. 17 is a sectional view taken at a line G-G in FIG. 16.

In FIGS. 16 and 17, a reference numeral 101 indicates a substrate. A first detecting electrode 102, a second detecting electrode 103 and a driving electrode 104 are provided on the substrate 102.

A reference numeral 105 indicates a movable electrode. The movable electrode 105 is provided within a frame of a semiconductor material 106 by facing against the first detecting electrode 102, the second detecting electrode 103, and the driving electrode 104. The movable electrode 105 is elastically supported by a deformation 107. The movable electrode 105 has a weight 108 at one end (an end on the second detecting electrode 103 side herein).

A metal contact 109 extends to a doped region 110 through an oxide film 111. The doped region 110 extends downward and is in contact with the first detecting electrode 102, the second detecting electrode 103 and the driving electrode 104. The first detecting electrode 102, the second detecting electrode 103 and the driving electrode 104 may be provided on a different glass substrate. Alternatively, the first detecting electrode 102, the second detecting electrode 103 and the driving electrode 104 may be formed within the semiconductor material 106 by using a junction isolation technology or an oxide film isolation technology. The first detecting electrode 102, second detecting electrode 103 and driving electrode 104 in FIG. 17 are pn junction isolation embedded electrodes.

Next, a principle of acceleration detection by using such a conventional acceleration sensor will be described. FIG. 18 is a diagram for explaining a measuring principle by using the conventional acceleration sensor.

All of the first detecting electrode 102, the second detecting electrode 103 and the movable electrode 105 are conductive and are located by facing against each other. Capacitances C1 and C2 are provided between the first detecting electrode 102 and the movable electrode 105 and between the second detecting electrode 103 and the movable electrode 105, respectively. One end of the movable electrode 105, which is elastically supported by the deformation 107, has the weight 108. Therefore, the movable electrode 105 is sensitive to an acceleration in a depth direction of the semiconductor material 106. Then, the movable electrode 105 is easy to twist with respect to an axis linking the deformation 107. In other words, when an acceleration is applied in the depth direction of the semiconductor material 116 as indicated by an arrow 112, the movable electrode 105 twists with respect to the axis linking the deformation 107. Due to the twist of the movable electrode 105, an interelectrode distance on the capacitance C1 side is larger while an interelectrode distance on the capacitance C2 side is smaller between the capacitances C1 and C2. Therefore, a capacity value of the capacitance C1 decreases while a capacity value of the capacitance C2 increases. By differentially detecting the capacitance changes, the applied acceleration can be measured. When an acceleration is applied in a direction opposite to the arrow 112, the movable electrode 105 twists in a direction opposite to the above direction. Then, the capacity value of the capacitance C1 increases while the capacity value of the capacitance C2 decreases.

The conventional acceleration sensor uses an inertial force acting on the weight 108 when an acceleration is applied thereto to convert the acceleration to a twist of the movable electrode 105 and to changes in capacitances C1 and C2 between the first and second detecting electrodes 102 and 103 and the movable electrode 105. Thus, the acceleration can be measured. Therefore, as shown in FIG. 18, an amount of change d1 in interelectrode distance between the first and second detecting electrodes 102 and 103 and the movable electrode 105 providing the capacitances C1 and C2 when an acceleration is applied is smaller than an amount of change d2 at the end of the movable electrode 105 having the weight 108. In other words, in view of a conversion efficiency of an acceleration due to an inertial force acting on the weight 108 to an amount of displacement of the movable electrode when the acceleration is applied, the conventional acceleration sensor cannot obtain a larger amount of displacement d1 of an interelectrode distance than an amount of displacement d2 of the weight 108. Therefore, a much larger amount of displacement of the weight is required than an amount of change in an interelectrode distance, which is required for obtaining a change in capacitance detectable by the detecting circuit side. This means that the rigidity of the deformation 107 is reduced more than necessary. A sensitivity to acceleration other than in a detecting axis direction may occur, which is not desirable as the sensor. The possibility that the movable electrode 105 is in contact with the semiconductor material 106 and/or the substrate 101 may be increased. Thus, the impact resistance and/or reliability of the sensor are disadvantageously reduced.

The weight 108 is required to provide on the movable electrode 105 such that the movable electrode 105 can twists with respect to the deformation 107 when an acceleration is applied. However, the weight 108 is only provided at one end of the movable electrode 105. As a result, the center of gravity of the movable electrode 105 does not exist on the axis linking the deformation 107. Therefore, the balance of the movable electrode 105 is difficult to obtain when no acceleration is applied. In other words, the movable electrode 105 twists even at the initial state. Therefore, the balanced state of the movable electrode 105 is hard to maintain. Thus, the same initial values of the capacitances C1 and C2 are difficult to obtain. As a result, the precision of detection may be reduced, and/or the step of calibrating a detecting characteristic may be complicated, disadvantageously.

Furthermore, the movable electrode 105 twists largely when an excessive acceleration is applied. Thus, the end may touch the substrate 101 and destroy the sensor structure.

In addition, no device is provided for correcting a characteristic changed due to a temperature change in an environment in use. Thus, an error may occur in acceleration obtained by the environment in use disadvantageously.

In view of the construction, the first detecting electrode 102, the second detecting electrode 103 and the driving electrode 104 are formed as embedded electrodes in the semiconductor material 106. The first detecting electrode 102, second detecting electrode 103 and driving electrode 104 and the metal contact 109 are connected electrically through the doped region 110. The depth of the first detecting electrode 102, second detecting electrode 103, driving electrode 104 as embedded electrodes and the doped region 110 in the semiconductor material 106 is limited by the processing technology physically. Due to the limitation and the detection principle, the flexibility in designing an amount of displacement of the movable electrode 105 decreases. Furthermore, the processing method is complicated, and the production cost increases disadvantageously.

The present invention was made in order to solve these problems. It is an object of the invention to obtain a more highly reliable acceleration sensor for detecting an acceleration in a direction of a detection axis in a highly sensitive manner and for suppressing a sensitivity to the other axes by improving the rigidity of the movable part.

It is another object of the invention to obtain an acceleration sensor having a construction with higher flexibility in design.

It is another object of the invention to obtain an acceleration sensor with higher impact resistance whereby the acceleration sensor is hard to damage when an excessive impact is applied thereto.

It is another object of the invention to obtain an acceleration sensor, which is small and inexpensive and can be mass-manufactured.

It is another object of the invention to obtain an acceleration sensor, which can detect accelerations in directions of three axes.

### DISCLOSURE OF INVENTION

An acceleration sensor according to the invention includes a first and a second fixed electrodes provided on a substrate, a movable electrode which is provided above the first and second fixed electrodes by facing against them, and elastically and swingably supported on the substrate by a first elastic supporting body, a mass which is elastically supported on the substrate by a second elastic supporting body and is movable in response to an acceleration in a direction perpendicular to the substrate, and a linking portion for linking the movable electrode and the mass at a position away from a swing axis of the movable electrode by a predetermined distance. In this case, an acceleration is measured based on changes in a first capacitance by the first fixed electrode and the movable electrode and a second capacitance provided by the second fixed electrode and the movable electrode. Therefore, the displacement amount at the end of the movable electrode can be larger than the displacement amount of the mass when an acceleration is applied. In other words, a large detected capacity change can be obtained by a small displacement of the mass. Therefore, an acceleration sensor for detecting an acceleration with high sensitivity can be obtained without decreasing the rigidity of the torsion bar more than necessary. By improving the rigidity of the movable part, the sensitivity to the other axes is suppressed. Thus, a high impact resistant and highly reliable acceleration sensor can be obtained.

The movable electrode may be surrounded by the mass such that the center of gravity of the movable electrode and the center of gravity of the mass can coincide each other. Therefore, the balance of the movable electrode is maintained also at the initial state. Thus, the same initial capacity values of the capacitances can be obtained between the first fixed electrode and the movable electrode and between the second fixed electrode and the movable electrode. Therefore, the precision in measurement can be stabilized, and the calibration step can be easier.

A self-diagnosis electrode is provided to face against the mass on the substrate for checking the operation of the acceleration sensor by applying a voltage between the self-diagnosis electrode and the mass. As a result, even when an acceleration is not applied, a voltage may be applied between the self-diagnosis electrode and the mass to cause electrostatic gravity between them, to forcibly drive the mass. Then the movable electrode can swing with respect to the torsion bar. Therefore, the function can be self-diagnosed regarding whether the sensor structure is not destroyed.

A driving electrode is provided facing against the movable electrode on the substrate for driving a movable electrode to a predetermined position by applying a voltage between the driving electrode and the movable electrode. Thus, the acceleration sensor may be also of the servo type for returning a twist of a movable electrode caused in response to an applied acceleration to the original state by adjusting a voltage to be applied to the driving electrode. Therefore, the detection characteristic can be stabilized. Additionally, the possibility that the movable electrode and the substrate touch each other is extremely decreased. As a result, an highly reliable acceleration sensor can be obtained.

A correcting electrode is provided facing against the mass on the substrate for correcting a characteristic change due to a temperature change in an environment in use. Thus, an error in an acceleration obtained in the environment in use can be prevented.

A first capacitance voltage transformer for transforming a capacitance generated between the first and second fixed electrodes and the movable electrode to a voltage, a second capacitance voltage transformer for transforming a capacitance generated between the mass and the correcting electrode to a voltage, and a processor for computing an output value from the first capacitance voltage transformer and an output value from the second capacitance voltage transformer are provided. Thus, a characteristic change can be certainly corrected by using the correcting electrode.

By providing a second and a third acceleration sensors each for measuring an acceleration in a direction horizontal to the substrate surface, the second acceleration sensor and the third acceleration sensor are arranged to respond to accelerations in directions orthogonal to each other, an acceleration sensor for detecting accelerations in three-axis directions can be obtained.

At least the movable electrode, the mass, the first bar, the second bar and the third bar may be integrally formed by polysilicon. Thus, the acceleration sensor can be manufactured easily. Furthermore, as the mass of the movable portion can be reduced significantly, the sensor structure is hard to destroy even when an excessive acceleration is applied. Therefore, the impact resistance can be improved.

Furthermore, at least the movable electrode, the mass, the first bar, the second bar and the third bar may be integrally formed by monocrystal silicon. Thus, the acceleration sensor can be manufactured easily. Additionally, the thicknesses of the movable electrode and mass can be adjusted easily. The mass of the mass and/or the capacitance can be set arbitrarily. Accordingly, the flexibility in designing the acceleration sensor can be increased.

### BRIEF DESCRIPTION OF THE DRAWINGS

FIG. 1 is a plan view of an acceleration sensor according to Embodiment 1 of the invention;

FIG. 2 is a diagram showing a sectional structure of the acceleration sensor according to Embodiment 1 of the invention and is a section view taken at a line A-A in FIG. 1;

FIG. 3 is a diagram showing a sectional structure of the acceleration sensor according to Embodiment 1 of the invention and is a section view taken at a line B-B in FIG. 1;

FIG. 4 is a diagram showing an operation state of the acceleration sensor according to Embodiment 1 of the invention when an acceleration is applied and is a section view taken at the line A-A in FIG. 1;

FIG. 5 is a diagram showing an operation state of the acceleration sensor according to Embodiment 1 of the invention when an acceleration is applied and is a section view taken at the line B-B in FIG. 1;

FIG. 6 is a diagram showing an operation state of the acceleration sensor according to Embodiment 1 of the invention when an acceleration is applied and is a section view taken at the line A-A in FIG. 1;

FIG. 7 is a diagram showing an operation state of the acceleration sensor according to Embodiment 1 of the invention when an acceleration is applied and is a section view taken at the line B-B in FIG. 1;

FIG. 8 is a plan view of an acceleration sensor according to Embodiment 2 of the invention;

FIG. 9 is a diagram showing a sectional construction of the acceleration sensor according to Embodiment 2 of the invention and is a section view taken at a line C-C in FIG. 8;

FIG. 10 is a diagram showing a sectional structure of the acceleration sensor according to Embodiment 2 of the invention and is a section view taken at a line D-D in FIG. 8;

FIG. 11 is a block diagram of a correction circuit in the acceleration sensor according to Embodiment 2 of the invention;

FIG. 12 is a plan view of an acceleration sensor according to Embodiment 3 of the invention;

FIG. 13 is a diagram showing a sectional structure of the acceleration sensor according to Embodiment 3 of the invention and is a section view taken at a line E-E in FIG. 12;

FIG. 14 is a diagram showing a sectional structure of the acceleration sensor according to Embodiment 3 of the invention and is a section view taken at a line F-F in FIG. 12;

FIG. 15 is a plan view of an acceleration sensor according to Embodiment 4 of the invention;

FIG. 16 is a plan view of a conventional acceleration sensor;

FIG. 17 is a section view of the conventional acceleration sensor and is a section view taken at a line G-G in FIG. 16; and

FIG. 18 is a section view of the conventional acceleration sensor, which is taken at a line G-G in FIG. 16 and which shows an operation state when an acceleration is applied.

### BEST MODE FOR CARRYING OUT THE INVENTION

Embodiment 1

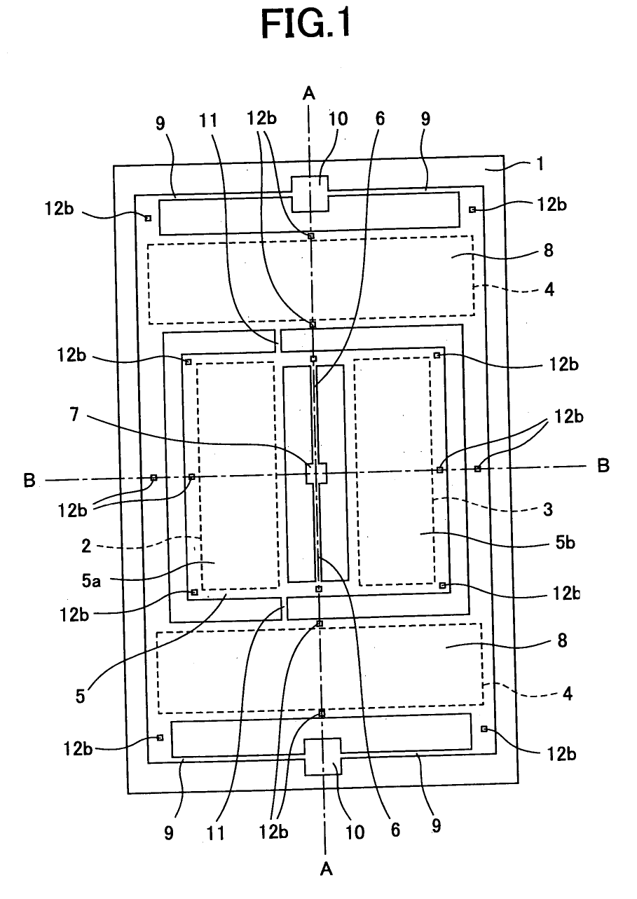

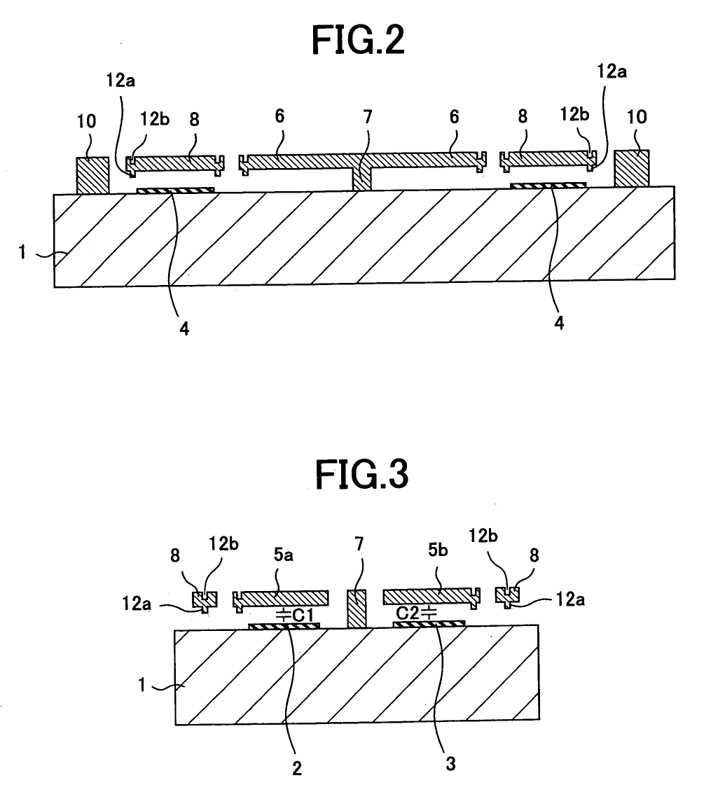

FIG. 1 is a plan view of an acceleration sensor according to Embodiment 1 of the invention. FIGS. 2 and 3 are section views taken at lines A-A and B-B, respectively, in FIG. 1. A construction of the acceleration sensor according to Embodiment 1 of the invention will be described with reference to these diagrams. A reference numeral 1 indicates a silicon substrate. An insulating film is preferably provided on the surface. The insulating film is not shown for simple description. A low-stress silicon nitride film deposited by LPCVD method is suitable for the insulating film. A first fixed electrode 2, a second fixed electrode 3 and a self-diagnosis electrode 4 are provided on the silicon substrate 1. The first fixed electrode 2, second fixed electrode 3 and self-diagnosis electrode 4 can be formed simultaneously by etching a polysilicon film deposited by LPCVD method, for example.

A reference numeral 5 is a movable electrode. The movable electrode 5 is placed above the first fixed electrode 2 and the second fixed electrode 3 by spacing from and facing against them. The movable electrode 5 is linearly symmetrical with respect to its center line A-A. One side (region 5a on the left side) of the movable electrode 5 faces against the first fixed electrode 2. The other side (region 5b on the right side) faces against the second fixed electrode 3.

A reference numeral 6 indicates a torsion bar. The torsion bar 6 is provided on the center line A-A of the movable electrode 5. By opening the periphery of the part to be the torsion bar 6, the movable electrode 5 and the torsion bar 6 can be integrally formed.

The movable electrode 5 is elastically supported on the silicon substrate 1 by the torsion bar 6 through an anchor 7. The movable electrode 5 is adapted to swing with respect to the torsion bar 6. With this construction, the capacitance C1 constituted by the first fixed electrode 2 and the movable electrode 5, and the capacitance C2 constituted by the second fixed electrode 3 and the movable electrode 5 form a differential capacitance.

A reference numeral 8 indicates a mass. The mass 8 is placed above the self-diagnosis electrode 4 by spacing from and facing against this. The mass 8 surrounds the movable electrode 5 by spacing from the movable electrode 5. The mass 8 is elastically supported on the silicon substrate 1 by a supporting bar 9 through an anchor 10. The mass 8 is adapted to be movable in accordance with the acceleration in a direction of thickness of the silicon substrate 1.

A reference numeral 11 indicates a link bar for physically linking the movable electrode 5 and the mass 8. The movable electrode 5 and the mass 8 are linked by the link bar 11 on only one side of both sides with respect to the center line of the movable electrode at a position away from the center line A-A of the movable electrode by a predetermined distance. In the example in FIG. 1, only the left side region 5a of the movable electrode 5 is liked by the link bar 11. The movable electrode 5 and the mass 8 are linked at two points on both sides of the movable electrode. The distances from the center line of the movable electrode 5 to link bars are equal. The link bar 11 is provided closer to the center line than to the end of the movable electrode 5.

Each reference numeral 12a indicates a slight projection projected to the silicon substrate 1 side of the movable electrode 5 and the mass 8. Reference numeral 12b indicates a depression on the surface opposite to the surface having the projections 12a there on, provided by forming of the projection 12a.

An example of a method of manufacturing an acceleration sensor according to Embodiment 1 with this construction will be described.

First of all, the first fixed electrode 2, the second fixed electrode 3 and the self-diagnosis electrode 4 are formed on the silicon substrate 1. These electrodes can be formed simultaneously by etching a polysilicon film deposited by LPCVD method, for example.

Next, a PSG film or the like is formed as a sacrifice layer. The sacrifice layer is processed in a desired depression-projection form. The depression-projection form can be obtained by repeatedly forming a mask on the sacrifice layer and etching the sacrifice layer.

Then, a polysilicon film is formed. The polysilicon film is patterned in a desired form. Then, by etching and removing the sacrifice layer selectively, an acceleration sensor shown in FIG. 1 is obtained. Desirably, the polysilicon film to be used is of a low stress and does not have a distribution of stress in the thickness direction. The thickness is about 2 to 4 μm typically.

In producing the acceleration sensor by using this method, the distance between the first fixed electrode 2 and second fixed electrode 3 and the movable electrode 5 can be designed arbitrarily and thus, the capacitances C1 and C2 can be changed easily, by changing the thickness of the sacrifice film to be formed. By changing the depth of each depression of the sacrifice layer at a position corresponding to the mass 8, the thickness of the mass 8, that is, the weight can be designed arbitrarily.

Furthermore, in order to form the movable electrode 5, torsion bar 6, link bar 11, mass 8, supporting bar 9 and anchors 7 and 10, a polysilicon films can be deposited and etched collectively. Also in order to form the first fixed electrode 2, second fixed electrode 3 and self-diagnosis electrode 4, a polysilicon film can be deposited and etched collectively. What is needed is only to process a polysilicon film deposited on the silicon substrate 1, no cementing multiple substrates is not required, and therefore, the number of manufacturing steps is reduced and the mass production is also possible. Therefore, the manufacturing costs may be reduced significantly. Furthermore, the size can be reduced.

All of the movable portions including the movable electrode 5, torsion bar 6, link bar 11, mass 8 and supporting bar 9 may be formed by using a polysilicon film. As a result, the mass of the movable portions can be reduced significantly. Even when an excessive acceleration is applied, the sensor structure is hard to destroy. Therefore, the impact resistance can be improved.

As described above, in the acceleration sensor according to Embodiment 1 of the invention, the size of the first fixed electrode 2 and the second fixed electrode 3 is 250 μm×50 μm typically. A distance between the first electrode 2 and second fixed electrode 3 and the movable electrode 5 is 2 μm typically. In this case, the initial values of the capacitances C1 and C2 may be about 0.55 pF.

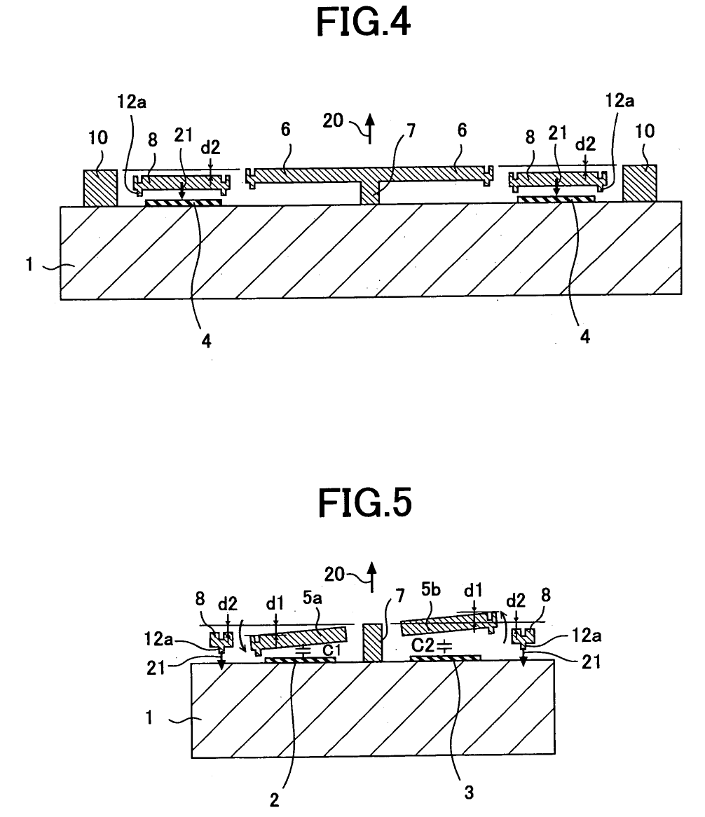

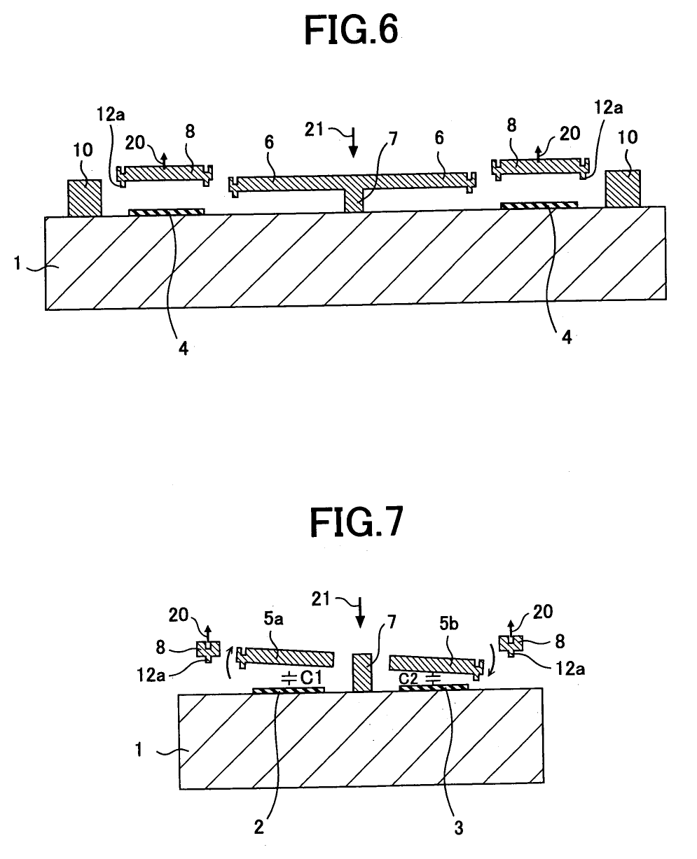

Next, the principle of acceleration detection will be described with reference to FIGS. 4 and 7. FIGS. 4 and 5 are diagrams each showing an operation state when an acceleration is applied in a direction (indicated by an arrow 20) perpendicular to the surface of the silicon substrate. FIGS. 4 and 5 are section views taken at lines A-A and B-B, respectively, in FIG. 1. FIGS. 6 and 7 are diagrams each showing an operation state when an acceleration is applied in a direction (indicated by an arrow 21) perpendicular to the surface of the silicon substrate surface. FIGS. 6 and 7 are section view taken at the line A-A and B-B, respectively, in FIG. 1.

As shown in FIGS. 4 and 5, when an acceleration is applied in the direction (indicated by the arrow 20) perpendicular to the silicon substrate 1, an inertia force acts on the mass 8. Since the mass 8 is elastically supported by the supporting bar 9 so as to move in the direction perpendicular to the silicon substrate 1, the mass 8 displaces in the direction (indicated by the arrow 21) opposite to that of the applied acceleration due to the inertia force. As the movable electrode 5 is physically linked with the mass 8 through the link bar 11 on the left side of the center line A-A, due to the downward displacement of the mass 8, the left side region 5a of the movable electrode 5 is also pressed downward. The movable electrode 5 is elastically supported by the torsion bar 6. Therefore, when the left side region 5a is displaced downward, the right side region 5b displaces upward like a seesaw. The interelectrode distance is reduced due to the twist-vibration of the movable electrode 5. Therefore, the capacity value of the capacitance C1 generated between the first fixed electrode 5 and the left side region 5a of the movable electrode 5 is increased. On the other hand, the capacity value of the capacitance C2 generated between the second fixed electrode 3 and the right side region 5b of the movable electrode 5 is reduced because the interelectrode distance is increased. By differentially detecting the changes in the capacitances C1 and C2, the applied acceleration can be measured.

In the acceleration sensor according to Embodiment 1, the link bar 11 linking the movable electrode 5 and the mass 8 is provided at the middle part of the movable electrode 5. As shown in FIGS. 4 and 5, the displacement amount d1 at the end of the movable electrode 5 can be made larger than the displacement amount d2 of the mass 8 when an acceleration is applied. In other words, a large detected capacity change can be obtained by a small displacement of the mass 8. Therefore, an acceleration sensor for detecting an acceleration with high sensitivity can be obtained without decreasing the rigidity of the torsion bar 6 more than necessary. Therefore, the reliability can be also improved.

When the direction of an applied acceleration is opposite to the above-described direction, the displacement direction of the mass 8, the twist direction of the movable electrode 5 and the changes in the capacitances C1 and C2 are only inverted from those described above as shown in FIGS. 6 and 7. Apparently, an acceleration can be measured in the same manner.

As shown in FIG. 1, by arranging the torsion bar 6 and the supporting bar 9 to intersect each other, the mass 8 and the movable electrode 5 can be adapted not to move against the acceleration in a direction horizontal to the silicon substrate 1. In other words, the sensitivity to accelerations with respect to the other axes, which are not desirable for the sensor, can be prevented.

Since the movable electrode 5 is surrounded by the mass 8 to make the center of gravity of both of them coincident, the balance of the movable electrode 5 can be maintained at the initial state. Thus, the same initial capacity value of the detecting capacitances C1 and C2 can be obtained. Therefore, the precision in measurement can be stabilized, and the calibration step can be easier.

Next, a self-diagnosis function will be described. The self-diagnosis electrode 4 is provided on the silicon substrate 1 facing against the mass 8. By applying voltage between the self-diagnosis electrode 4 and the mass 8, electrostatic gravity is caused between them. Thus, the mass 8 can be displaced downward as shown in FIGS. 4 and 5. By forcibly displacing the mass 8 in this way even when an acceleration is not applied, the left side region 5a of the movable electrode 5 linked with the mass 8 through the link bar 11 is displaced downward. The right side region 5b of the movable electrode 5 is displaced upward. As a result, in the same manner as the case when an acceleration is applied, the capacitance changes can be caused in the capacitances C1 and C2. By detecting capacitance changes caused in this way, the function can be self-diagnosed regarding whether the acceleration sensor according to the invention is destroyed or not, whether the characteristic changes or not and so on.

In order to improve the characteristic and reliability of the acceleration sensor, the acceleration sensor according to this embodiment has following devices.

The first point is that the torsion bar 6 and the supporting bar 9 intersect as shown in FIG. 1. Thus, the sensitivity to acceleration within the plain of the silicon substrate, which is not desirable for sensors, that is, the sensitivity to accelerations with respect to the other axes can be suppressed.

The second point is that the projections 12a are located properly as shown in FIGS. 1 to 7. Thus, the movable electrode 5 and the mass 8 are prevented from adhering to the silicon substrate 1 at a step of removing a sacrifice layer in manufacturing processing. Furthermore, even when an excessive acceleration is applied and the movable electrode 5 twists significantly, the movable electrode 5 is prevented from touching the first fixed electrode 2 or the second fixed electrode 3, which might result in a short circuit. These projections 12a can be formed easily by forming depressions in advance on a sacrifice layer before a polysilicon film is deposited thereabove on which the movable electrode 5 and the mass 8 will be formed.

Embodiment 2

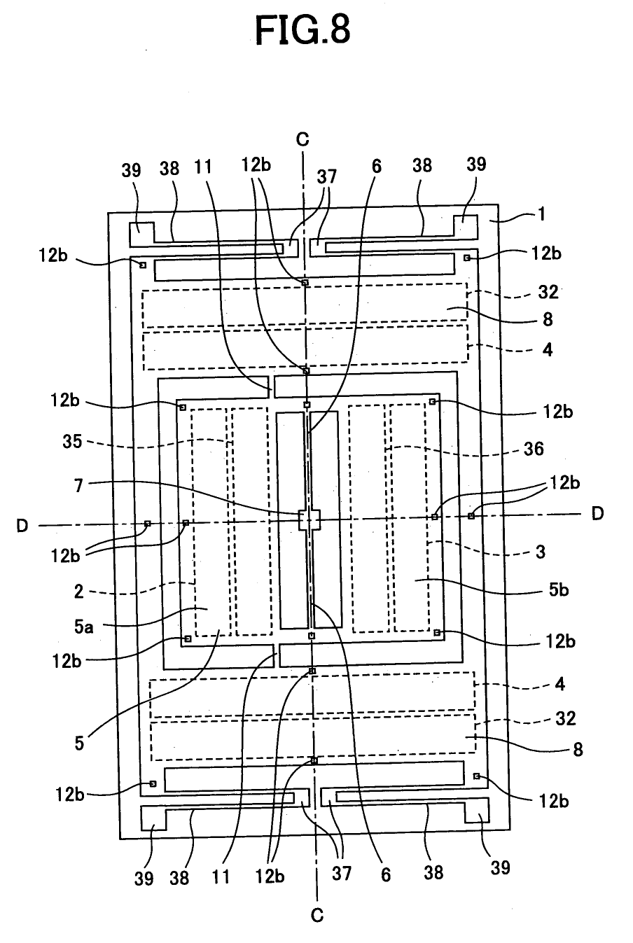

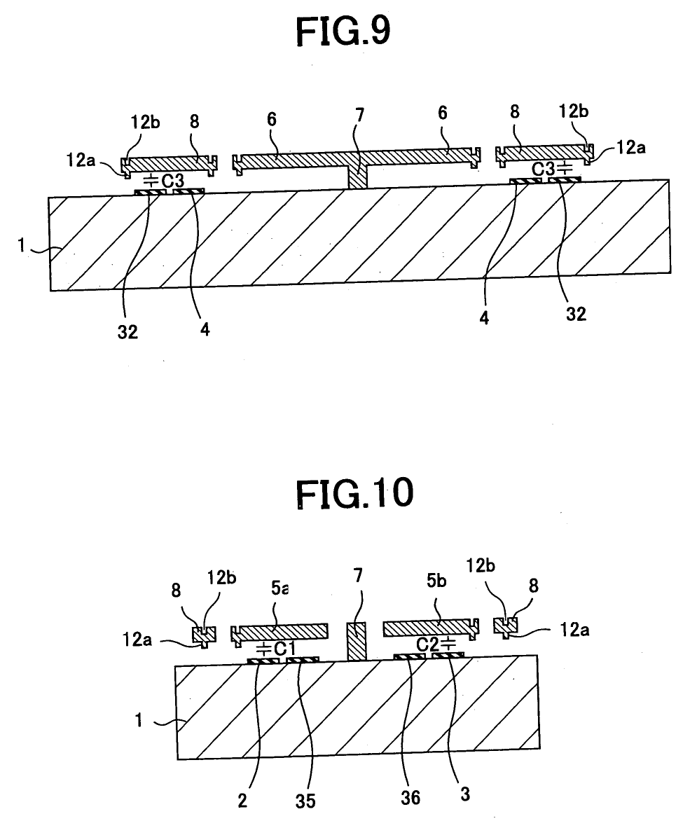

FIG. 8 is a plan view of an acceleration sensor according to Embodiment 2 of the invention. FIGS. 9 and 10 are sectional views taken at lines C-C and D-D, respectively, in FIG. 8.

Embodiment 2 is characterized in that a correcting electrode 32 is provided by the side of a self-diagnosis electrode 4 provided on a silicon substrate 1 by facing against a mass 8, in that driving electrodes 35 and 36 are provided near a first fixed electrode 2 and a second fixed electrode 3 provided on the silicon substrate 1 by facing against a movable electrode 5, and in that a supporting bar 38 having a bending portion 37 is provided as a supporting bar for elastically supporting the mass 8 with respect to the silicon substrate 1 and the supporting bar 38 elastically supports the mass 8 with respect to the silicon substrate 1 through an anchor 39.

In FIGS. 8 to 10, the same reference numerals as those shown in FIGS. 1 to 7 indicate the same elements as those according to Embodiment 1 or equivalent elements.

The correcting electrode 32 is an electrode provided for compensating a characteristic change due to a temperature change or the like. When a temperature of an environment in which the acceleration sensor is used changes, a warp occurs due to a difference in thermal expansion coefficients between members included in the acceleration sensor. As a result, capacitances C1 and C2 may change. A change in the capacitances C1 and C2 and a change in a capacitance C3 provided by the mass 8 and the movable electrode 5 have the same tendency in many cases. Therefore, by detecting a change in the capacitance C3, the changes in capacitances C1 and C2 can be corrected based on the change in the capacitance C3.

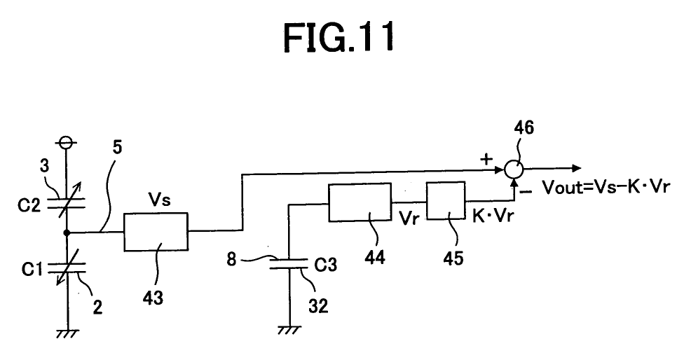

FIG. 11 is a block diagram of a correction circuit in the acceleration sensor according to Embodiment 2 of the invention.

As shown in FIG. 11, an output value Vs resulted from transformation of changes in capacitances C1 and C2 to voltages by a first capacitance voltage transformer 43 and an output value Vr resulted from transformation of a change in the capacitance C3 to voltages by a second capacitance voltage transformer 44 are computed by using a voltage processor 46 so as to obtain:

Vout=Vs−K·Vr

Thus, the output value Vout can be obtained from which only the change amount is removed. Here, K is a correcting coefficient.

In this way, by providing the correcting electrode 32 facing against the mass 8 on the substrate 1, the change in characteristic due to a temperature change, for example, of an environment in use can be corrected. Therefore, an error in acceleration obtained in the environment in use can be prevented.

The driving electrodes 35 and 36 are electrodes each used for suppressing twists of the movable electrode 5 and used when the present acceleration sensor is used as that servo type. In other words, when the movable electrode 5 twists with respect to the torsion bar 6 due to an applied acceleration and the capacitances C1 and C2 are unbalanced, the unbalance amount are returned as a feedback. Then, a voltage corresponding to the unbalance amount is applied to the driving electrode 35 or driving electrode 36. Thus, the twist of the movable electrode 5 is returned to the original balanced state by electrostatic gravity caused between the movable electrode 5 and the driving electrode 35 or driving electrode 36. The acceleration can be obtained based on the voltage applied to the driving electrode 35 or driving electrode 36 in order to return to the balanced position.

By using the acceleration as such of a servo type acceleration sensor, malfunctions or breakage caused by the contact of the movable electrode 5 with the silicon substrate 1 can be prevented. Thus, the reliability can be improved.

Furthermore, by using the bending bar 38 having a bending portion 37 as a supporting bar as described above, the axial force imposed on the supporting bar can be reduced even when a residual stress of the polysilicon film exists. Therefore, the buckling can be prevented.

Embodiment 3

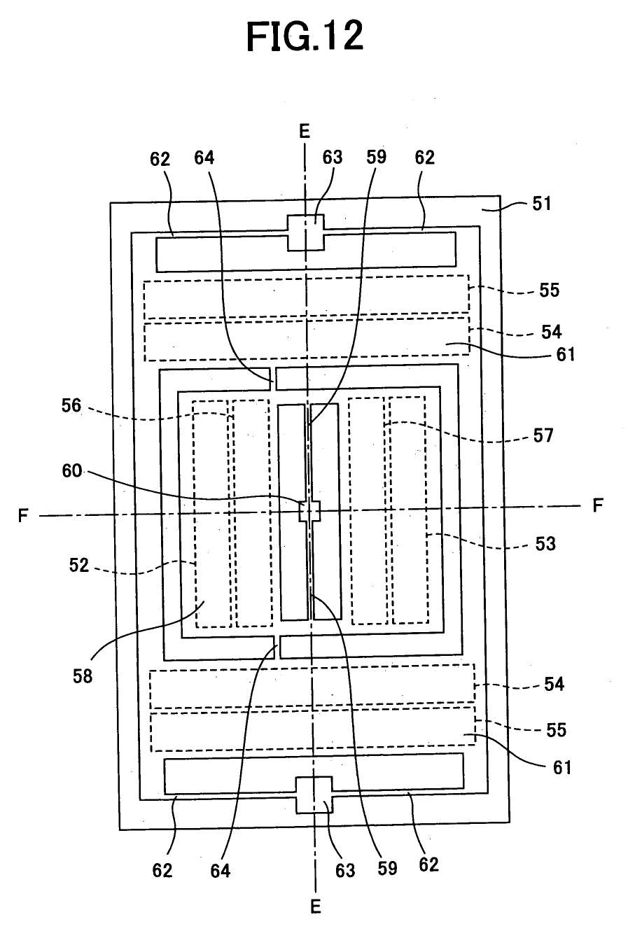

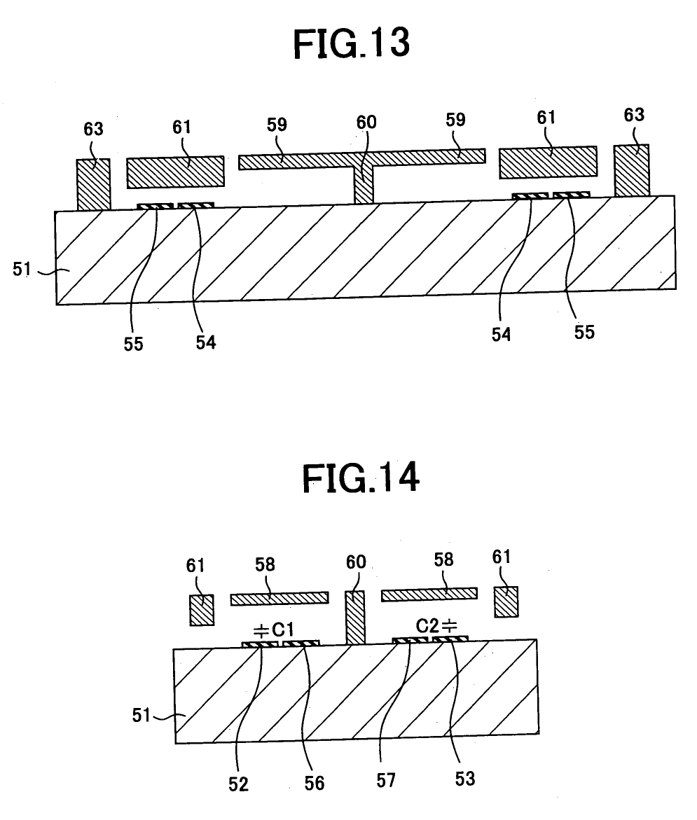

FIG. 12 is a plan view of an acceleration sensor according to Embodiment 3 of the invention. FIGS. 13 and 14 are sectional diagrams taken at lines E-E and F-F, respectively, in FIG. 12.

In Embodiments 1 and 2, various electrodes are formed on the silicon substrate 1 by using a polysilicon film. Embodiment 3 is different from Embodiments 1 and 2 largely in that the various electrodes are formed of a metal thin film or monocrystal silicon on a glass substrate.

In FIGS. 12 to 14, a reference numeral 51 indicates a glass substrate. A first fixed electrode 52, a second fixed electrode 53, a self-diagnosis electrode 54, a correcting electrode 55 and driving electrodes 56 and 57 made of a metal thin film such as that of aluminum and gold are provided on the glass substrate 51. A movable electrode 58 is provided above the first fixed electrode 52, the second fixed electrode 53 and the driving electrodes 56 and 57 by being spaced from and facing against them. The movable electrode 58 is elastically supported on the glass substrate 51 by a torsion bar 59 through an anchor 60. Thus, the movable electrode 58 can swing with respect to the torsion bar 59. A mass 61 is located above the self-diagnosis electrode 54 and the correcting electrode 55 by spacing from and facing against them. The mass 61 is elastically supported on the glass substrate 51 by the supporting bar 62 through the anchor 63. The mass 61 can move in accordance with the acceleration in a direction perpendicular to the substrate surface of the glass substrate 51. Furthermore, the mass 61 is physically linked with the movable electrode 58 through the link bar 64.

The movable electrode 58, torsion bar 59, mass 61, supporting bar 62, link bar 64 and anchors 60 and 63 are integrally formed by monocrystal silicon.

An example of a method of manufacturing the acceleration sensor according to Embodiment 3 with this construction will be described.

First of all, the first fixed electrode 52, second fixed electrode 53, self-diagnosis electrode 54, correcting electrode 55 and driving electrodes 56 and 57 are formed on the glass substrate 51. These electrodes can be formed simultaneously by depositing and etching metal thin films collectively.

Next, a monocrystal silicon substrate is processed so that the movable electrode 58, torsion bar 59, mass 61, supporting bar 62, link bar 64 and anchors 60 and 63 can be formed.

A mask is formed on the back surface side of the monocrystal silicon substrate in the positions corresponding to the anchors 60 and 63. Then, the monocrystal silicon substrate is etched. This etching is continued by using Deep Reactive Ion Etching method (DRIE method), for example, until the thickness of the monocrystal silicon substrate to be etched, that is, until the thickness of the mass reaches to a desired thickness.

Next, a mask is formed on the back side of the parts, of the monocrystal silicon substrate in the positions, corresponding to the anchors 60 and 63 and the mass 61. Then, the monocrystal silicon substrate is etched. This etching is continued by using DRIE method, for example, until the thickness of the monocrystal substrate to be etched, that is, until the thickness of the movable electrode 58 reaches to a desired thickness.

Next, after removing the mask, the back side of the anchors 60 and 63 is pasted on the glass substrate. A mask is formed on a front side of the parts corresponding to the movable electrode 58, torsion bar 59, mass 61, supporting bar 62, link bar 64, and anchors 60 and 63. The monocrystal silicon substrate is etched through from the front side. Thus, these components can be formed, and the acceleration sensor according to Embodiment 3 can be obtained.

In this way, the acceleration sensor according to Embodiment 3 can be produced by forming the movable electrode 58, torsion bar 59, mass 61, supporting bar 62, link bar 64 and anchors 60 and 63 by processing a single monocrystal substrate.

In this way, etching is performed in two steps such that the mass 61 can be thick and the movable electrode 58 can be thin. Thus, the mass of the mass 61 can be large. Therefore, the sensitivity can be improved. Additionally, the distance between the movable electrode 58 and the glass substrate 51 can be large. Therefore, the movable electrode 58 is hard to touch the glass substrate 51. As a result, the impact resistance and reliability can be improved.

The acceleration sensor according to Embodiment 3 can be easily manufactured. Additionally, the thickness of the movable electrode and mass can be adjusted easily. The flexibility in designing the acceleration sensor can be improved such as arbitrarily setting a mass of the mass and a capacitance.

The etching has been described to be a two-step process, however, the etching may be performed in one step. In this case, the thickness of the mass 61 becomes same with that of movable electrode 58. Therefore, the manufacturing process can be simplified advantageously.

Embodiment 4

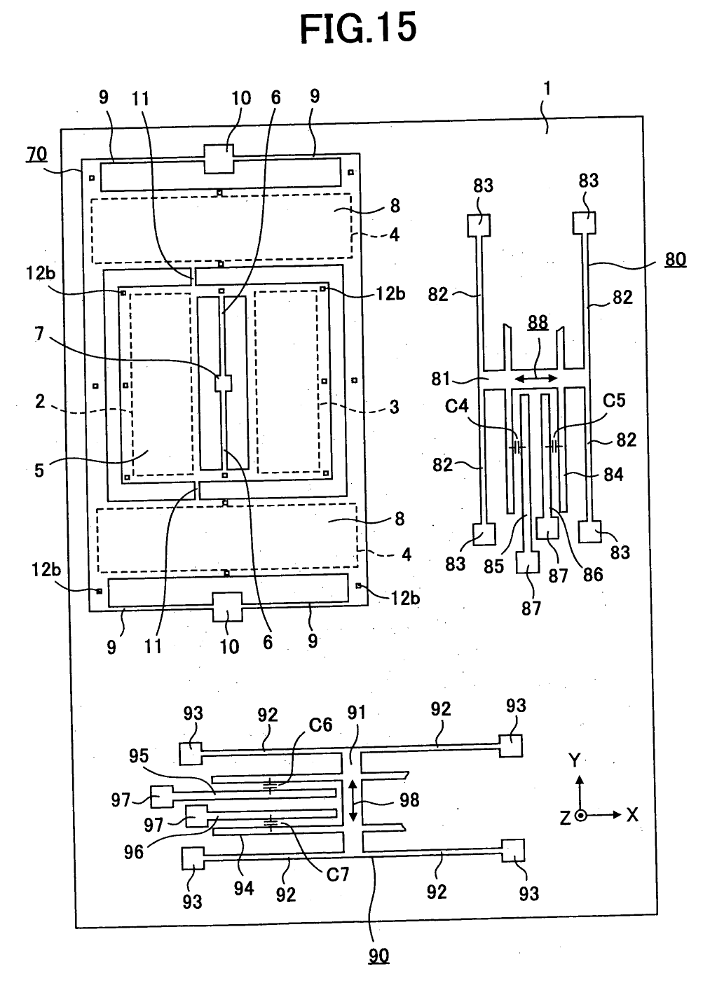

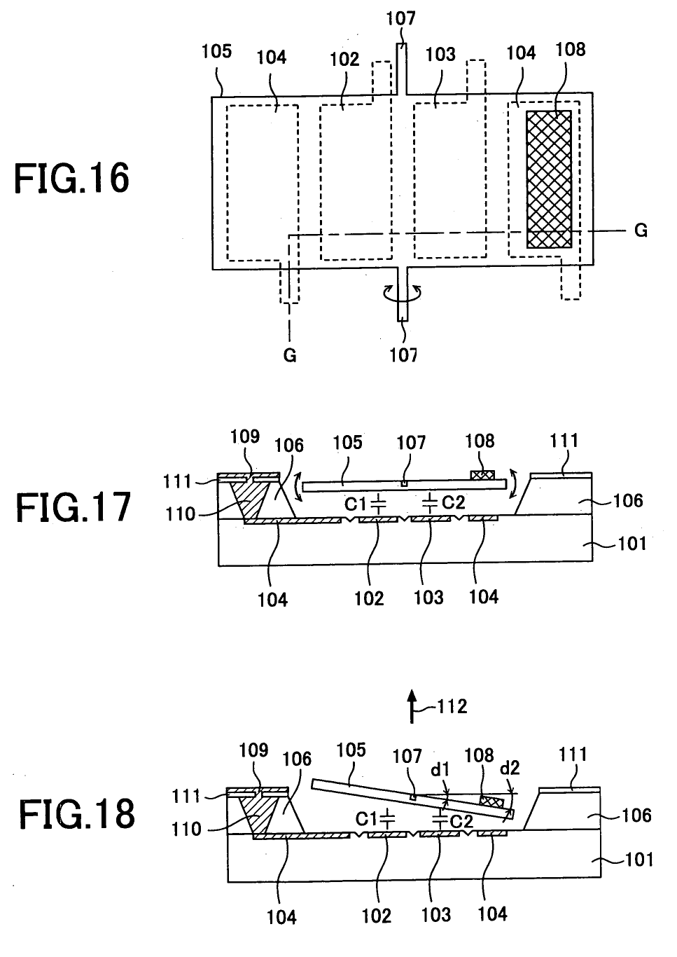

FIG. 15 is a plan view of an acceleration sensor according to Embodiment 4 of the invention.

The acceleration sensor according to Embodiment 4 includes the acceleration sensor for detecting an acceleration in a direction perpendicular to the substrate surface of the silicon substrate 1 described in Embodiment 1 and a second and a third acceleration sensors each for detecting an acceleration in a direction of the inside of the surface of the silicon substrate 1.

In FIG. 15, a reference numeral 70 indicates a first acceleration sensor for detecting an acceleration in a direction (Z-axis direction) perpendicular to the silicon substrate 1. A reference numeral 80 indicates a second acceleration sensor for detecting an acceleration in a direction (X-axis direction) horizontal to the silicon substrate 1. A reference numeral 90 indicates a third acceleration sensor for detecting an acceleration in a direction (Y-axis direction) horizontal to the silicon substrate 1 and orthogonal to the X-axis direction. In FIG. 15, the same reference numerals in FIGS. 1 to 7 indicate the same or equivalent components as those in Embodiment 1.

The same one as the acceleration sensor according to Embodiment 1 is used as the first acceleration sensor 70. Alternatively, the acceleration sensor according to Embodiment 2 or 3 may be used as the first acceleration sensor 70.

Next, the second acceleration sensor 80 will be described.

A reference numeral 81 indicates a mass. Four supporting bars 82 extending in a direction perpendicular to the X-axis are connected to both ends of the mass 81. These supporting bars 82 are spaced from and are provided above the silicon substrate 1. These supporting bars 82 are fixed on the silicon substrate by an anchor 83. The mass 81 is elastically supported on the silicon substrate 1 by using the supporting bar 82. The mass 81 displaces in response to an acceleration in the X-axis direction (indicated by an arrow 88). The mass 81 has many comb-form movable electrodes 84 extending in a direction perpendicular to the X-axis. Here, only few of them are illustrated for simplification.

Fixed electrodes 85 and 86 are provided by facing against these comb-form movable electrodes 84. Both of the fixed electrodes 85 and 86 are fixed on the silicon substrate 1 through an anchor 87. The fixed electrodes 85 and 86 are provided such that one of distances between the fixed electrodes 85 and 86 and the facing movable electrodes 84 can be smaller and the other distance can be larger when the mass 81 displaces in the X-axis direction.

The fixed electrode 85 and the movable electrode 84 constitute a capacitance C4. The fixed electrode 86 and the movable electrode 84 constitute a capacitance C5. A differential capacitance includes the capacitances C4 and C5 by having the movable electrode 84 in common.

By differentially detecting changes in the capacitances C4 and C5, an applied acceleration in the X-axis direction can be measured.

Next, the third acceleration sensor 90 will be described. The third acceleration sensor 90 has the same construction as that of the second acceleration sensor except that a mass 91, a supporting bar 92, an anchor 93, a movable electrode 94, a fixed electrodes 95 and 96 in the third acceleration sensor 90 are located in a direction orthogonal to the second acceleration sensor.

A capacitance C6 is provided between the fixed electrode 95 and the movable electrode 94. A capacitance electrode C7 is provided between the fixed electrode 96 and the movable electrode 94. A differential capacitance includes the capacitances C6 and C7 by having the movable electrode 94 in common.

By differentially detecting changes in the capacitances C6 and C7, an applied acceleration in the Y-axis direction (indicated by an arrow 98) can be measured.

As described above, by providing a capacitance type acceleration sensor having a mass displaceable in response to accelerations in the X-, Y-Z-directions, which are orthogonal to each other, an acceleration sensor can be obtained for detecting accelerations in the three axis directions in one sensor chip.

### INDUSTRIAL APPLICABILITY

As described above, the acceleration sensor according to the invention is suitable for being used as a high impact resistant and highly reliable acceleration sensor.

1. An acceleration sensor, comprising:
first and second fixed electrodes provided on a substrate; a movable electrode which is provided above the first and second fixed electrode by facing against them, and is elastically supported on the substrate by a first elastic supporting body and is swingable; a mass which is elastically supported on the substrate by a second elastic supporting body and is movable in response to an acceleration in a direction perpendicular to the substrate; and a linking portion for linking the movable electrode and the mass at a position away from a swing axis of the movable electrode by a predetermined distance,
wherein an acceleration is measured based on changes in a first capacitance provided by the first fixed electrode and the movable electrode and a second capacitance provided by the second fixed electrode and the movable electrode.

2. The acceleration sensor according to claim 1, wherein the movable electrode is surrounded by the mass such that the center of gravity of the movable electrode and the center of gravity of the mass coincide each other.

3. The acceleration sensor according to claim 1, further comprising a self-diagnosis electrode provided facing against the mass on the substrate for checking an operation of the acceleration sensor by applying a voltage between the self-diagnosis electrode and the mass.

4. The acceleration sensor according to claim 1, further comprising a driving electrode provided facing against the movable electrode on the substrate for driving the movable electrode to a predetermined position by applying a voltage between the driving electrode and the movable electrode.

5. The acceleration sensor according to claim 1, further comprising a correcting electrode provided facing against the mass on the substrate for correcting a capacitance provided by the first and second fixed electrodes and the movable electrode based on a capacitance provided between the correcting electrode and the mass.

6. The acceleration sensor according to claim 5, further comprising: a first capacitance voltage transformer for transforming a capacitance provided between the first and second fixed electrodes and the movable electrode to a voltage; a second capacitance voltage transformer for transforming a capacitance provided between the mass and the correcting electrode to a voltage; and a processor for computing an output value from the first capacitance voltage transformer and an output value from the second capacitance voltage transformer.

7. The acceleration sensor according to any one of claims 1 to 6, further comprising a second and a third acceleration sensors each for measuring an acceleration in a direction inside the substrate, wherein the second acceleration sensor and the third acceleration sensor are arranged to respond to accelerations in directions orthogonal to each other.

8. The acceleration sensor according to claim 1, wherein at least the movable electrode, the mass, the first elastic supporting body, the second elastic supporting body and the linking portion are integrally formed by polysilicon.

9. The acceleration sensor according to claim 1, wherein at least the movable electrode, the mass, the first elastic supporting body, the second elastic supporting body and the linking portion are integrally formed by monocrystal silicon.
